(19) United States
(12) Patent Application Publication
(10) Pub. No.: US 2009/0158697 A1
(43) Pub. Date: Jun. 25, 2009

(54) AIR FILTER

(75) Inventors: Edward G. MAGEE, Mississauga (CA); John MAGEE, Campbellville (CA); Frank SISCO, Cambridge (CA)

Correspondence Address: LANG MICHENER LLP, Brookfield Place, SUITE 2500, 181 BAY STREET, TORONTO, ON, M5J 2T7, CA

(73) Assignee: Delta M Incorporated, Milton (CA)

(21) Appl. No.: 11/962,889

(22) Filed: Dec. 21, 2007

(51) Int. Cl. B01D 29/46

(52) U.S. Cl. 55/492

(57) ABSTRACT

Amongst other things, there is provided an air filter that is for use in a duct having one or more walls. The air filter comprises a peripheral frame that includes a substantially resilient and compressible casing, and a substantially rigid internal skeleton within the casing. The air filter also comprises a filter element attached about its entire perimeter in sealed relation to the casing of the peripheral frame. The filter element is adapted to remove contaminants from air passing through the duct. When the air filter is in use, it is positioned in the duct such that the casing of the peripheral frame is compressed against the walls of the duct in substantially air-sealed relation therewith.

### FIELD OF THE INVENTION

The present invention relates to the field of air filters and more particularly to an improved air filter for use in an HVAC system.

### BACKGROUND OF THE INVENTION

A phenomenon known in the art as “duct disease” and/or “sick building syndrome” affect approximately 50% of buildings (i.e., homes, office towers, and other structures) in North America. The use of air filters placed throughout ductwork in the heating, ventilation and air conditioning (“HVAC”) systems of these buildings assists in removing, for example, dirt, dust, pollen, mold, bacteria and other pathogens from air passing therethrough, thus minimizing the discharge of such contaminants from ductwork vents supplying air to the work and living areas of such buildings.

The filtration media used in such air filters is commonly a fibrous material (woven or non-woven) such as, for example, various types of cotton, polyester, glass fibers and the like. Such media typically has a relatively open matrix of fibers arranged to provide for the free flow of air therethrough, while at the same time operating to physically entrain the contaminants present in the incoming air. More recently, filtration media have been provided that are substantially rigid, in that they need not be stretched between two structures in order to be substantially planar. These filtration media are additionally configured so as to allow for removal of a wide variety of sizes of particles from air.

Prior art air filters are commonly of the single use variety, such that they are thrown away without washing once acceptable flow rates of air therethrough are no longer attainable, as occurs when the fiber matrix of the filtration media becomes clogged with contaminants.

It is also well known in the art to provide filtration media in a pleated configuration in order to increase the effective surface area of the filtration media (i.e., the surface area exposed to incoming airflow) beyond the cross-sectional area of the passageway or duct in which the particular filter is employed. This allows collection of a greater quantity of contaminants in the filtration media before unacceptable air flow rates are encountered, thus extending the mean time before replacement of the filter becomes necessary.

The utilization of single-use air filters results in a great deal of waste, which is ecologically undesirable. Attempts have been made to develop air filters that can be reused and/or recycled, thereby to lessen waste, whilst still providing acceptable levels of filtration. In order to be reusable, air filters must be capable of being vigorously washed, such that enough of the contaminants entrained in the matrix of the filtration media are removed to achieve acceptably high flow rates after such washing. Moreover, such vigorous washing is desirably carried out at elevated water temperatures (i.e., above about 70 degrees Celsius) and with powerful cleaning/disinfectant agents if any pathogens included in the entrained contaminants are to be neutralized. It should be noted that the filtration media typically employed in prior art single-use air filters is not sufficiently robust or durable to withstand the repeated vigorous washing cycles desired in this regard—an exception being the more rigid filtration media briefly discussed above.

A washable filter is disclosed in U.S. patent application Ser. No. 11/855,470, filed Sep. 14, 2007, which Application shares common inventors with the present application, and the teachings of which prior Application are hereby incorporated herein by reference. In that prior Application, the washable filter is provided as an apparatus with multiple components. These components include a rigid frame and a filter element releasably attachable thereto, with one or more of the frame and the filter element being collapsible. The combined features of washability and collapsibility are advantageous by reason of, without limitation, a reduction in the volume of space necessary to ship such washable filters from the buildings in which they are used to the facilities at which they are washed, and back. However, it has been subsequently realized that the assembly of the multiple components together that is required for the use of these collapsible filters, and the disassembly that is required in order to perform washing operations can be disadvantageous. Such assembly and disassembly requires extra knowledge, effort, and skill on the part of those servicing the filters and/or those shipping and/or washing them. This inconvenience has, in some instances, been an obstacle to converting those using single use filters to the use of washable filters, despite the other advantages which flow from such conversion.

As noted above, in order to be effective for re-use, a reusable air filter must display substantially the same air flow capability and filtering effectiveness on its first use as on subsequent uses. While there will, of course, be some degradation in the effectiveness of reusable air filters over time (necessitating eventual replacement), the number of cycles that a single reusable air filter may be washed and reused before requiring such replacement must be significant enough to justify the additional costs associated with manufacturing a more robust filter element and with repeated washing of same. Otherwise, in the absence of legislative intervention, significant resistance to conversion by users from single use air filters to reusable air filters will continue.

It is also desirable to have an opportunity to test the contaminants entrained by used air filters at the washing/testing facility for the presence of pathogens and the like, which may be useful in the identifying sources of contamination within a building, which contaminants may be responsible for causing said duct disease or sick building syndrome. Such testing is less likely to occur on a routine basis in the case of single-use air filters.

Additionally, prior art air filters are often susceptible to what is known in the art as “blow-by”, wherein a volume of the incoming air passes between the filter and the duct walls without passing through the filter element, with the result that some air is left unfiltered. This occurs, for example, in pleated filter media by way of gaps formed at the end of the folds between adjacent pleats, which gaps permit such air to pass laterally, between the filter element and the duct walls without being filtered.

Blow-by may also occur by way of air passing through gaps between the perimeter of the filter and the wall of any duct in which the filter is used. These gaps may be caused by, for example, items (e.g., rivets, screws, and other fasteners) protruding into the passageway of the duct, unusual shaped ducts (which render it difficult to closely fit filters therein) and other phenomena. Filters having a metal, plastic, cardboard (or similarly rigid) frame surrounding the filter medium are particularly susceptible to this latter type of blow-by. Prior art washable filters consisting of an outer frame and a filter element held inside of the frame may provide some flexibility that will aid to some degree in avoiding such blow-by; however, the positioning of the frame exterior to the filter medium is inherently limiting in terms of resistance to blow-by. In some instances, the frame itself is not configured to allow for sufficient compression thereof against the walls of the duct, resulting in an inability to effect a seal therewith that air cannot penetrate without being filtered. In such instances, air will pass around the filter, rather than through it. As such, in order for such external frame filters to be effective, they must be very closely sized to the duct in which they are to be used. This may result in additional costs, and, in many instances, appropriate tolerancing is simply not feasible.

Single use filters will often be cut so as to have gaps therein to accommodate protrusions such as, for example, the rivets, screws, and other fasteners, discussed above which project into the duct. Of course, such a filter cannot be re-used, and its effectiveness can be severely limited by cutting out a section thereof so as to allow it to fit within the duct.

Accordingly, there exists a need for an air filter that exhibits improved sealing capabilities within a duct in which the filter is used, thereby to minimize filter blow-by. It is also highly preferable for the air filter to be capable of being used and washed repeatedly, even at higher wash temperatures.

### SUMMARY OF THE INVENTION

In accordance with the present invention there is disclosed an air filter for use in a duct having one or more walls. The air filter includes a peripheral frame and a filter element centrally positioned within the peripheral frame. The filter element is preferably washable on a repeated basis at elevated temperatures. The peripheral frame comprises a substantially resilient and compressible casing, and a substantially rigid internal skeleton within the casing. The filter element is attached about its entire perimeter in sealed relation to the casing of the peripheral frame, and is adapted to remove contaminants from air passing through the duct. When the air filter is in use, it is positioned in the duct such that the casing of the peripheral frame may be compressed against the walls of the duct in substantially air-sealed relation therewith. The casing may have an inwardly directed face and an outwardly directed face. The outwardly directed face may abut the walls of the duct when the filter is in use. The internal skeleton may include one or more side segments. The casing may be comprised of one or more filter media. The filter element may have a plurality of pleats formed therein, each of which may be comprised of a plurality of fold lines and two adjacent sloping side surfaces. Adjacent ones of the side segments of the internal skeleton may be contiguous with one another. The casing and the filter element may preferably be comprised of the same filter media. The filter element may be glued and/or stitched and/or releasably attached to the peripheral frame, and preferably to the inner face of the casing.

It is thus an object of this invention to obviate or mitigate at least one of the above mentioned disadvantages of the prior art.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a front right perspective view, from above, of an air filter according to the present invention;

FIG. 2 is a sectional view along line 2-2 of FIG. 1; and,

FIG. 3 is a view as in FIG. 1, with the encircled portion 3 of FIG. 1 shown with the casing and filter element cut away therefrom to reveal a corner portion of the internal skeleton.

### DETAILED DESCRIPTION OF A PREFERRED EMBODIMENT

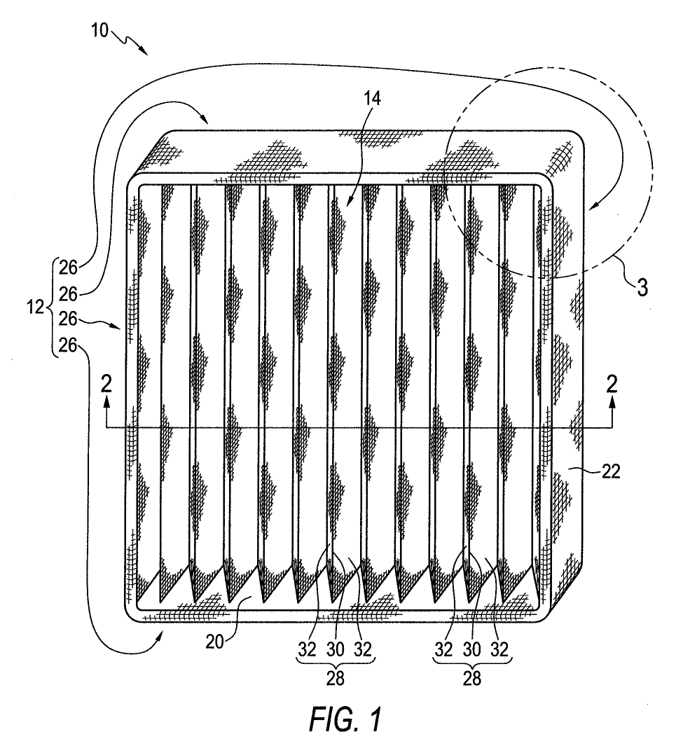

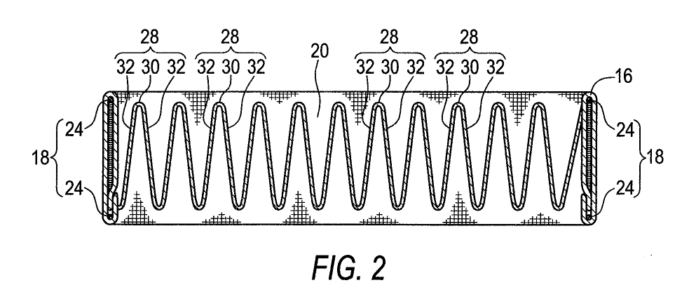

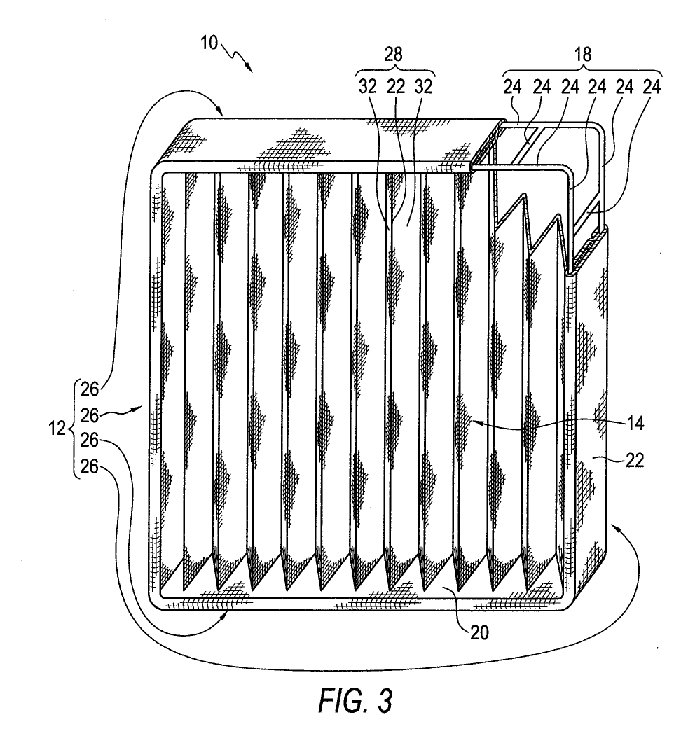

Looking to the Figures, there will be seen an air filter 10 for use in a duct (not shown) having one or more walls (not shown). As shown in section in FIG. 2, the air filter 10 includes a peripheral frame 12 comprising a substantially resilient and compressible casing 16, and a substantially rigid internal skeleton 18 within the casing 16. The internal skeleton 18 includes one or more side segments 26, adjacent ones of them being contiguous with one another, as seen in FIG. 1. The casing 16 has an inwardly directed face 20 and an outwardly directed face 22, as seen in FIGS. 1 and 3.

A centrally positioned filter element 14 is attached about its perimeter (preferably about the entirety thereof) in sealed relation to the inwardly directed face 20 of the casing 16 of the peripheral frame 12. This attachment may be by way of, for example and without limitation, gluing and/or stitching, and may or may not be releasable.

The filter element 14 is adapted to remove contaminants from air passing through the duct. The casing 16 may also be comprised of one or more filter media, and may also remove contaminants from air passing through the duct. The air filter 10 is preferably washable, such that contaminants entrained therein may be removed therefrom, in particular from the filter element 14 and, in some instances, also from the casing 16. The filter element 14 may but need not necessarily, have a plurality of pleats 28 formed therein, as shown in the Figures, with each pleat 28 comprising a plurality of fold lines 30 and two adjacent sloping side surfaces 32. One skilled in the art will appreciate that, in instances of peripheral frames 12 and filter elements 14 of suitable geometry, multiple orientations of the filter element 14 within the peripheral frame 12 may be possible without limiting the effectiveness of the air filter 10.

The internal skeleton 18 includes a plurality of rails 24, seen in section in FIG. 2, and via cutting away of a portion in FIG. 3 for ease of illustration. The rails 24 run throughout the peripheral frame 12, so as to provide some rigidity therewithin, with a pair of parallel rails 24 together forming one of said side segments 26. The provision of a substantially resilient compressible casing 16 allows for greater compressibility of the peripheral frame 12 of the air filter 10, and an increased tolerance level in terms of fitting in the duct in an air-sealed fashion with its walls than is otherwise possible with prior art external frames constructed from more rigid materials, such as metal, plastic, cardboard and the like. This combination of rigid and compressible materials in the construction of the peripheral frame 12 is both novel and unobvious, providing the unexpected advantages referenced above.

Each of the rails 24 may preferably, but need not necessarily, be constructed from materials that are resistant to corrosion and/or abrasion, including various metals and plastic materials. Alternately, the rails 24 may be provided with a coating that is resistant to abrasion and/or corrosion, which coating may, but need not necessarily be composed of a powdered metal substance, or the like, that is chemically or magnetically adhered to the rails 24.

While it is shown in the Figures as being substantially square, one skilled in the art will appreciate that the air filter 10 may be constructed so as to be shaped to tightly fit within a variety of ducts (not shown) through which filtration of air is necessary, such ducts having various cross-sectional geometries including, for example, and without limitation, rectangular, circular, elliptical and triangular. That is, the air filter 10 will be constructed so as to substantially match the shape of the duct in which it is used, so as to substantially occlude the cross-sectional area thereof. In this regard, one skilled in the art will recognize that each of the rails 24 need not be continuous throughout the casing 16 so as to provide required levels of rigidity for the air filter 10. Rather, discontinuities in the rails 24 could be provided in the cases of air filters 10 designed to be used in ducts having shapes that are unconventional or irregular due to design requirements and/or unusually large or numerous protrusions extending into same, thereby to impart additional flexibility into the internal skeleton 18 so as to facilitate fitment of the air filter 10 within such ducts, whilst retaining substantial sealing between the casing 16 and the walls of the duct.

When the air filter 10 is in use, it is positioned in the duct such that the casing 16 of the peripheral frame 12 is compressed against the walls of the duct in substantially air-sealed relation therewith. The entire periphery of the air filter (i.e., the casing 16 of the peripheral frame 12) is preferably in such air-sealed relation with the duct, so as to substantially minimize blow-by. It will be appreciated that, in such positioning of the filter 10, the outwardly directed face 22 of the casing 16 abuts, and is compressed against, the walls of the duct.

It is noted that the walls of the duct (not shown) may be configured so as to have one or more slots formed therein, into which slots the air filter 10 may fit and against which the casing 16 will be compressed in an air-sealed, thereby exhibiting the same additional and advantageous sealing properties as in the instance described above.

Once the filter element 14 (and, possibly, but not necessarily, the casing 16) entrains its effective capacity of trapped contaminants, or has been in place for such a period that removal thereof is deemed appropriate, the air filter 10 is removed from the duct.

The air filter 10 may then be shipped in a closed container (e.g., a sealed cardboard box), to facilities (e.g., onsite, or remote from the building in which the air filter 10 is employed) whereat it may be tested and/or washed, so that it may be re-used.

Numerous cycles (i.e., fill to capacity, then wash and use again) may be made of each washable air filter 10 prior to the need to dispose of same. The number of uses may depend on, for example, the quality of the filter medium making up the filter element 14 and/or the casing 16, the volume of air flow and the volume of contaminant matter in such air flow that is caught in the filter element 14, and perhaps the casing 16, per unit time. Suitable filtration media making up each of the filter element 14 and the casing 16 may include, for example and without limitation, fibrous textile materials (woven or non-woven) such as, for example, various types of cotton, polyester, nylon, polyethylene, glass fibers and the like. In some embodiments, the casing 16 and the filter element 14 may advantageously be comprised of the same filter media.

Other modifications and alterations may be used in the design and manufacture of other embodiments according to the present invention without departing from the spirit and scope of the invention, which is limited only by the accompanying claims.

We claim:

1. An air filter for use in a duct having one or more walls, said air filter comprising:
(a) a peripheral frame comprising a substantially resilient and compressible casing and a substantially rigid internal skeleton within said casing; and,
(b) a filter element attached about its perimeter in sealed relation to said casing of said peripheral frame, wherein said filter element is adapted to remove contaminants from air passing through the duct;
wherein, when said air filter is in use, said air filter is positioned in the duct such that said casing of said peripheral frame is compressed against the walls of the duct in substantially air-sealed relation therewith.

2. An air filter according to claim 1, wherein said filter element is centrally positioned within said peripheral frame.

3. An air filter according to claim 1, wherein said air filter is washable.

4. An air filter according to claim 1, wherein said casing has an inwardly directed face and an outwardly directed face, and wherein said outwardly directed face abuts the walls of the duct when said filter is in use.

5. An air filter according to claim 1, wherein said internal skeleton includes one or more side segments.

6. An air filter according to claim 5, wherein adjacent ones of said side segments of said internal skeleton are contiguous with one another.

7. An air filter according to claim 1, wherein said casing is comprised of one or more filter media.

8. An air filter according to claim 1, wherein said casing and said filter element are both comprised of the same filter media.

9. An air filter according to claim 1, wherein said filter element has a plurality of pleats formed therein, each comprised of a plurality of fold lines and two adjacent sloping side surfaces.

10. An air filter according to claim 1, wherein said filter element is glued to said peripheral frame.

11. An air filter according to claim 1, wherein said filter element is stitched to said peripheral frame.

12. An air filter according to claim 1, wherein said filter element is releasably attached to said peripheral frame.

13. An air filter according to claim 1, wherein said filter element is attached about its entire perimeter to said casing of said peripheral frame.
